(19) United States
(12) Patent Application Publication
(10) Pub. No.: US 2016/0178728 A1
(43) Pub. Date: Jun. 23, 2016

(54) Indoor Positioning Terminal, Network, System and Method

(71) Applicant: Huawei Technologies Co., Ltd., Shenzhen (CN)

(72) Inventor: Yan Liu, Shenzhen (CN)

(21) Appl. No.: 15/054,729

(22) Filed: Feb. 26, 2016

Related U.S. Application Data
(63) Continuation of application No. PCT/CN2014/083877, filed on Aug. 7, 2014.

(30) Foreign Application Priority Data
Aug. 27, 2013 (CN) 201310378988.0

(51) Int. Cl. G01S 5/16; G01S 19/40; H04W 4/04; G01S 5/02

(52) U.S. Cl. CPC G01S 5/16; G01S 5/0263; G01S 19/40; H04W 4/04

(57) ABSTRACT

An indoor positioning terminal, network, system, and methods which relate to an indoor positioning terminal, including a memory, a camera, and a processor where the camera is configured to capture, with low exposure, a picture of an indoor lighting device, and the memory is configured to store indoor positioning map data, where the indoor positioning map data includes an indoor electronic map and three-dimensional data information of the indoor lighting device that use a same frame of reference, and the processor is configured to perform correlation matching between the three-dimensional data of the indoor lighting device and the captured picture of the indoor lighting device, and position a location of the positioning terminal on the indoor electronic map when the picture is acquired.

### CROSS-REFERENCE TO RELATED APPLICATIONS

This application is a continuation of International Application No. PCT/CN2014/083877, filed on Aug. 7, 2014, which claims priority to Chinese Patent Application No. 201310378988.0, filed on Aug. 27, 2013, both of which are hereby incorporated by reference in their entireties.

### TECHNICAL FIELD

Embodiments of the present disclosure relate to an indoor positioning terminal, network, system and method, and in particular, to a terminal, a network, a system, and a method in which positioning is implemented by capturing an image.

### BACKGROUND

Outdoor user location positioning and road navigation have been widely applied, for example, outdoor positioning and navigation are implemented using a global positioning satellite system (GPS). However, application of indoor positioning is still in the bud, and there has been no technology that can be applied in a large scale.

Here describes, using examples, an indoor wireless positioning technology, in which positioning is performed using signal strength of a BLUETOOTH beacon. BLUETOOTH is a short range wireless transmission technology with low power consumption. In a BLUETOOTH local area network access point that is installed indoors, a network is configured in a basic network connection mode that is based on multiple users. A terminal measures signal strength of various surrounding BLUETOOTH beacons. A change of wireless signal strength may represent a wireless signal transmission distance. Using one BLUETOOTH antenna, a general distance from the terminal to the BLUETOOTH antenna may be obtained. Therefore, if multiple BLUETOOTH antennas are used and distances from the terminal to these BLUETOOTH antennas are estimated, a general location of the terminal can be determined. A BLUETOOTH technology is mainly applied to short-range positioning. Advantages of a BLUETOOTH indoor positioning technology is a small equipment volume and easy integration into a personal digital assistant (PDA), a personal computer (PC), and a mobile phone. However, in a none line of sight wireless path, positioning accuracy of the technology deteriorates obviously. In a complex space environment or under interference of a human body to an electromagnetic wave, reduction of the accuracy and stability may also be caused. If a terminal to be positioned is in a moving state, the accuracy may further deteriorate. In addition, using a BLUETOOTH wireless positioning technology, it is easy to wrongly position another room that is separated by a wall. Generally, within a plane range of 100 meters×100 meters, positioning accuracy of BLUETOOTH wireless positioning is about 5 meters, and such accuracy is not enough in some applications.

### SUMMARY

Embodiments of the present disclosure provide a technology in which positioning is performed with reference to a lighting device.

According to some embodiments of the present disclosure, an indoor positioning terminal is provided, including a memory, a camera, and a control/positioning computing module, where the camera is configured to capture, with low exposure, a picture of an indoor lighting device. The memory is configured to store indoor positioning map data, where the indoor positioning map data includes an indoor electronic map and three-dimensional data information of the indoor lighting device that use a same frame of reference, and the control/positioning computing module is configured to perform correlation matching between the three-dimensional data of the indoor lighting device and the captured picture of the indoor lighting device, and position a location of the positioning terminal on the indoor electronic map when the picture is acquired.

In an exemplary embodiment, the positioning terminal further includes a communication module that is configured to download the indoor positioning map data from an indoor positioning server.

In an exemplary embodiment, the control/positioning computing module is configured to perform the correlation matching. The correlation matching has a fault tolerance processing capability. When there is a difference in some lighting devices between the picture of the indoor lighting device and the three-dimensional data information, a matching degree is estimated using another lighting device. The control/positioning computing module is further configured to send a found difference between the some lighting devices and the three-dimensional data information to the indoor positioning server using the communication module.

In an exemplary embodiment, the control/positioning computing module is further configured to acquire a wide angle that is used by the camera to capture the indoor picture. The control/positioning computing module is further configured to map the three-dimensional data of the indoor lighting device into a two-dimensional simulation view with a same wide angle according to the wide angle of the indoor picture, and then perform the correlation matching.

In an exemplary embodiment, the control/positioning computing module is further configured to acquire a three-dimensional space attitude of the camera, and the control/positioning computing module is further configured to perform the correlation matching with the three-dimensional data of the indoor lighting device according to an attitude the same as the three-dimensional space attitude of the camera.

In an exemplary embodiment, a wireless network communication module is further included, where the wireless network communication module is configured to measure signal strength of a wireless network, exchange information with the wireless network, and locate a general area in which the user terminal is located. The control/positioning computing module first performs, in the area, the correlation matching between the picture of the indoor lighting device and the three-dimensional data of the indoor lighting device.

In an exemplary embodiment, a satellite positioning system module is further included, and is configured to position a location of the terminal, where the location is used as a start point of indoor navigation of a next step.

In an exemplary embodiment, a satellite positioning system module is further included, and is configured to collect signals of some positioning satellites, where the signals of some positioning satellites are used to perform correction on the indoor positioning location with reference to existing indoor location information.

In an exemplary embodiment, the control/positioning computing module is further configured to control the camera to acquire two types of images. One type of image is used for indoor positioning, and the other type of image is used for a virtual reality display of a positioning result.

In an exemplary embodiment, the positioning terminal further includes a user interface that is configured to feedback positioning information to a user.

Indoor positioning solutions provided in the embodiments of the present disclosure are suitable for indoor positioning in a large building, where positioning accuracy is high, and positioning is less liable to be interfered, which improves applicability of the solutions.

According to some embodiments of embodiments of the present disclosure, a method for an indoor positioning terminal is further provided, including the following steps controlling a camera to acquire, with low exposure, an indoor image, performing correlation matching between three-dimensional data of a lighting device in the indoor image and three-dimensional data of an indoor lighting device that serves as a positioning reference, and positioning, according to a correlation between the three-dimensional data of the indoor lighting device and the indoor electronic map, a location of the terminal on the indoor electronic map when the picture is shot.

In an exemplary embodiment, the positioning step further includes outputting an orientation of the camera of the positioning terminal.

In an exemplary embodiment, the correlation matching further includes correlation matching having fault tolerance processing. When there is a difference in some lighting devices between the picture of the indoor lighting device and the three-dimensional data information, a matching degree is estimated using another lighting device. The following step is further included: sending a found difference between the some lighting devices and the three-dimensional data information to an indoor positioning server using a communication module.

In an exemplary embodiment, the following step is further included: acquiring a wide angle that is used by the camera to capture the indoor picture, and the correlation matching further includes matching the three-dimensional data of the indoor lighting device to a two-dimensional simulation view with a same wide angle according to the wide angle of the indoor picture, and then performing the correlation matching.

In an exemplary embodiment, the following step is further included: acquiring a three-dimensional space attitude of the camera, and the correlation matching further includes performing the correlation matching with the three-dimensional data of the indoor lighting device according to an attitude the same as the three-dimensional space attitude of the camera.

Indoor positioning solutions provided in the embodiments of the present disclosure are suitable for indoor positioning in a large building, positioning accuracy is high, and positioning is less liable to be interfered, which improves applicability of the solutions.

According to some embodiments of the present disclosure, an indoor positioning system is further provided, including a camera of a terminal, a positioning database, and a positioning computing module, where the camera of the terminal is configured to capture, with low exposure, a picture of an indoor lighting device. The positioning database is configured to store three-dimensional data information of an indoor lighting device that serves as a positioning reference, where the three-dimensional data information of the indoor lighting device and an indoor electronic map use a same frame of reference, and the positioning computing module is configured to perform correlation matching between the three-dimensional data of the indoor lighting device and the captured picture of the indoor lighting device, and position a location of the positioning terminal on the indoor electronic map when the picture is acquired.

In an exemplary embodiment, the positioning computing module is configured to perform the correlation matching. The correlation matching has a fault tolerance processing capability. When there is a difference in some lighting devices between the picture of the indoor lighting device and the three-dimensional data information, a matching degree is estimated using another lighting device. The positioning computing module is further configured to update the positioning database according to a found difference between the some lighting devices and the three-dimensional data information.

In an exemplary embodiment, the positioning computing module is further configured to output an orientation of the camera of the positioning terminal.

In an exemplary embodiment, the positioning computing module is further configured to acquire a wide angle that is used by the camera of the terminal to capture the indoor picture, and the positioning computing module is further configured to match the three-dimensional data of the indoor lighting device into a two-dimensional simulation view with a same wide angle according to the wide angle of the indoor picture, and then perform the correlation matching.

In an exemplary embodiment, the positioning computing module is further configured to acquire a three-dimensional space attitude of the camera of the terminal, and the positioning computing module is further configured to perform the correlation matching with the three-dimensional data of the indoor lighting device according to an attitude the same as the three-dimensional space attitude of the camera.

Indoor positioning solutions provided in the present disclosure are suitable for indoor positioning in a large building, where positioning accuracy is high, and positioning is less liable to be interfered, which improves applicability of the solutions.

According to some embodiments of the present disclosure, a method for a positioning network is provided, including the following steps: acquiring an indoor image that is obtained by a camera of a positioning terminal with low exposure, performing correlation matching between three-dimensional data of a lighting device in the indoor image and three-dimensional data of an indoor lighting device that serves as a positioning reference, and positioning, according to a correlation between the three-dimensional data of the indoor lighting device and the indoor electronic map, a location of the camera of the terminal on an indoor electronic map when the picture is shot.

In an exemplary embodiment, the positioning step further includes outputting an orientation of the camera of the positioning terminal.

In an exemplary embodiment, the correlation matching further includes correlation matching having fault tolerance processing. When there is a difference in some lighting devices between the picture of the indoor lighting device and the three-dimensional data information, a matching degree is estimated using another lighting device. The following step is further included: updating, according to a difference between the some lighting devices and the three-dimensional data information, the three-dimensional data of the indoor lighting device that serves as the positioning reference.

Indoor positioning solutions provided in the embodiments of the present disclosure are suitable for indoor positioning in a large building, where positioning accuracy is high, and positioning is less liable to be interfered, which improves applicability of the solutions.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other solutions from these accompanying drawings without creative efforts.

FIG. 1 is a structural diagram of an indoor positioning terminal;

FIG. 2 is a working orientation diagram of an indoor positioning terminal;

FIG. 3 is a low exposure picture captured by the positioning terminal in FIG. 2;

FIG. 4 is a horizontal mapping diagram of indoor space;

FIG. 5 is a stereogram of area 1 in FIG. 4;

FIG. 6 is a picture of a lighting device that is captured at location A by a camera of a positioning terminal;

FIG. 7 is a picture of a lighting device that is captured at location B by a camera of a positioning terminal;

FIG. 8 is an exemplary diagram of a positioning terminal entering the indoor space in FIG. 4;

FIG. 9 is a schematic diagram of a positioning error of the positioning terminal in FIG. 8;

FIG. 10 is a schematic diagram of two types of image processing of a positioning terminal;

FIG. 11 is a schematic diagram of a positioning terminal and a positioning server;

FIG. 12 is a schematic diagram of navigation of a positioning terminal in a building;

FIG. 13 is a schematic diagram of positioning by a positioning terminal with assistance of a positioning satellite;

FIG. 14 is a positioning terminal that integrates indoor and outdoor technologies;

FIG. 15 is a flowchart of a method for a positioning terminal;

FIG. 16 is a flowchart of another method for a positioning terminal;

FIG. 17 is a structural diagram of an indoor positioning network and a positioning terminal;

FIG. 18 is another structural diagram of an indoor positioning network and a positioning terminal;

FIG. 19 is still another structural diagram of an indoor positioning network and a positioning terminal;

FIG. 20 is a flowchart of a method for an indoor positioning network;

FIG. 21 is a flowchart of another method for an indoor positioning network; and

FIG. 22 is a flowchart of still another method for an indoor positioning network.

### DESCRIPTION OF EMBODIMENTS

The following clearly and describes the technical solutions in the embodiments of the present disclosure with reference to the accompanying drawings in the embodiments of the present disclosure.

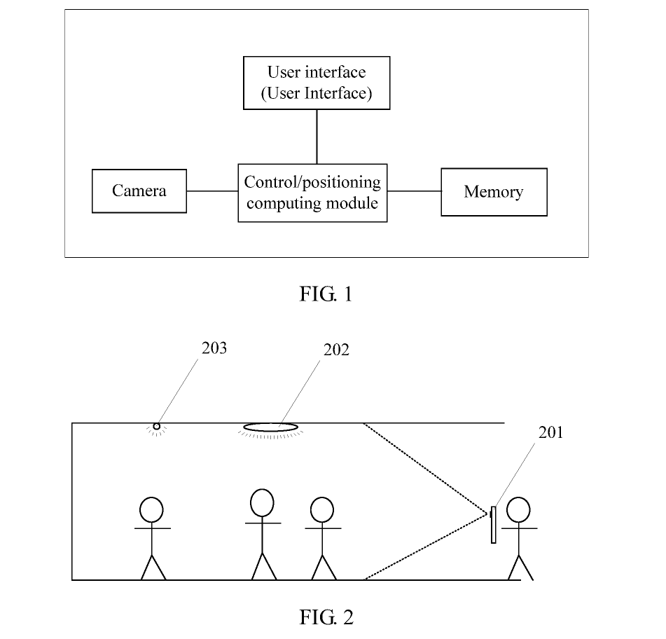

As shown in FIG. 1, FIG. 1 shows Embodiment 1 of a terminal used for indoor positioning. The positioning terminal includes a control/positioning computing module, a camera, and an indoor positioning map memory. The control/positioning computing module is a processor that has a computing resource, which may be a general central processing unit (CPU), or may be a dedicated processor, for example, a logic circuit such as a graphic processing unit (GPU), an application-specific integrated circuit (ASIC), or an field-programmable gate array (FPGA) or an accelerated computing module formed by specific hardware, or may be formed by multiple parts in the foregoing examples, which run in a parallel manner or a primary/secondary manner. The camera is formed by a photosensitive integrated circuit (such as a complementary metal-oxide semiconductor (CMOS)), a lens, and a control circuit, and the camera can be controlled by the control/positioning computing module to shoot a low exposure picture and a normal exposure picture. The low exposure picture is implemented by controlling the camera to shorten exposure time or zoom out an aperture of the lens. The camera is configured to shoot a picture of an indoor lighting device during indoor positioning. In this embodiment, the positioning terminal positions a location using an indoor bright object as a reference. The indoor positioning map memory is also a memory, which may be formed by one or more of a random access memory (RAM), a flash memory, an electrically programmable read-only memory (ROM), and the like. Positioning map data stored in the indoor positioning map memory may be data downloaded using a communications network, for example, using a wireless communications network, or may be copied using a pluggable memory. The positioning terminal may further include a user interface (UI), which may be configured to display positioning information or navigation information. The UI of the positioning terminal may also inform a user of location information or navigation information using a voice, or may interact with the user in another information notification manner, such as vibration, beeping, and blinking.

The positioning terminal implements positioning by taking a picture, and definition of the picture is an important guarantee of correctly identifying a location of the positioning terminal. However, on an indoor occasion, a camera may use a longer shutter cycle for proper exposure, which results in that motion blur is more likely to appear in a hand-held camera. On the indoor occasion, a contradiction between exposure time needed in imaging and imaging definition always exists, and affects the imaging definition.

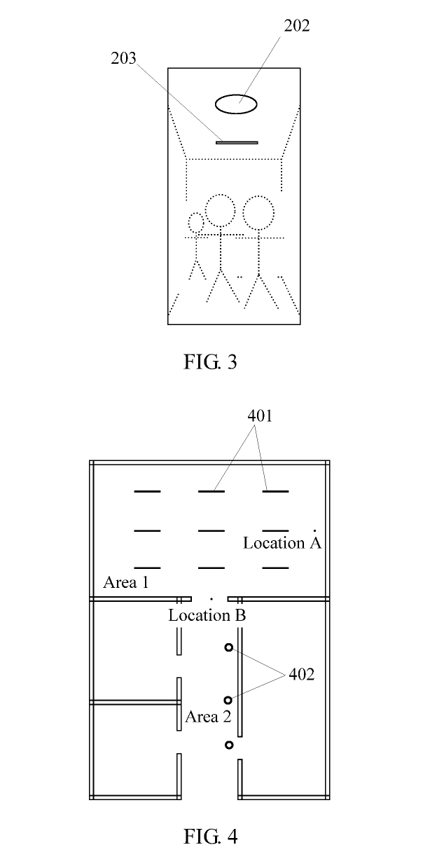

A positioning terminal 201 in FIG. 2 acquires an indoor image using a camera, where the image is obtained by the camera with low exposure under control of control/positioning computing module. The image is shown in FIG. 3, and bright lighting devices 202 and 203 obtain normal exposure, but a surrounding environment obtains excessively low exposure, which results in unclearness of the image. The image may be shot using a faster shutter, and an increase of a shutter speed can avoid a problem of motion blur caused by shaking of the terminal. A bright lighting device herein may be a bright window, an indoor lighting facility, and the like. Certainly, another low exposure manner may also be used. Brightness of a lighting device in a low exposure picture significantly contrasts with that of other indoor views (view). Therefore, during image processing, a surrounding background can be conveniently suppressed and eliminated, and a feature of the lighting device can be accurately extracted.

FIG. 4 is a horizontal mapping diagram of indoor space, where 401 is an elongated lighting device, and 402 is a circular lighting device. An indoor electronic map may be drawn according to a plane graph of an indoor channel and a room, where the indoor electronic map may be composed of data that can be read by a computer, thereby facilitating the user in copying. Although this embodiment can work with a planar indoor electronic map. However, a shopping mall generally has an escalator, a split-level structure, and the like, and a three-dimensional map can display more details to the user. Therefore, the indoor electronic map is preferably a stereo electronic map.

Regardless of whether the lighting device is punctiform, circular, elongated, rectangular, or in another irregular shape, these lighting devices may be recorded on the indoor electronic map using three-dimensional data in order to generate a database of three-dimensional data of a positioning reference that can be processed by the computer. The following generally describes, using an indoor positioning map, three-dimensional data of the indoor electronic map and a lighting device that serves as a positioning reference. Three-dimensional data coordinates of the lighting device may also be correlated with the indoor electronic map and use a same frame of reference such that a location positioned according to three-dimensional space data of the indoor lighting device can point to the indoor electronic map. Using a same frame of reference may be that the three-dimensional space data and the indoor electronic map use a same third-party frame of reference, or may be that one party takes the other party as a frame of reference, and vice versa. The indoor positioning map may be downloaded to the memory of the positioning terminal in advance.

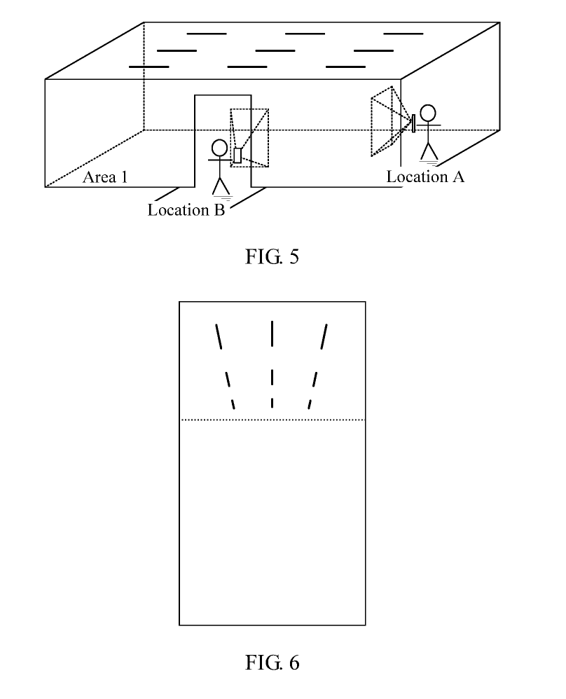

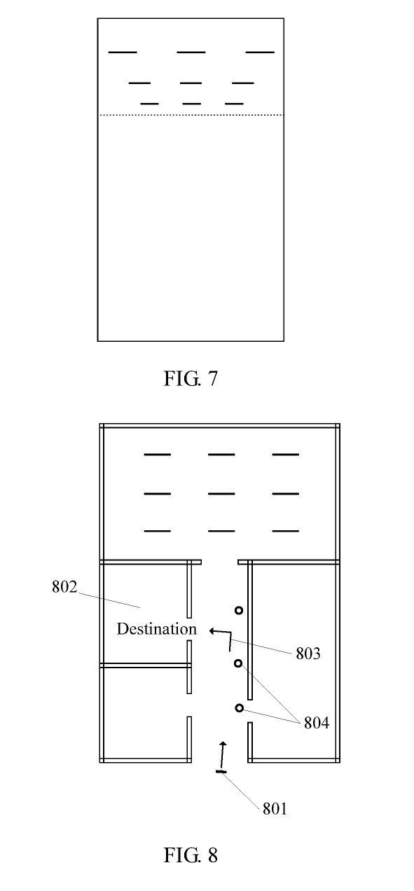

FIG. 5 is a stereogram of area 1 in FIG. 4. The lighting device is observed from a perspective of the terminal that is roaming indoor, and the lamp presents different two-dimensional images in different perspectives. Indoor low exposure pictures acquired by the positioning terminal held by the user at location A and location B are shown in FIG. 6 and FIG. 7. FIG. 6 and FIG. 7 are used for correlation matching of positioning and are also referred to as positioning pictures. FIG. 6 and FIG. 7 mainly display the lighting device. The rest of the picture is underexposure, and a tone of the picture is dim. Therefore, the rest of the picture is easily suppressed in image processing, thereby conveniently extracting a feature of the lighting device.

FIG. 6 and FIG. 7 acquired by the camera of the positioning terminal are similar to two-dimensional views that are of the lighting device in three-dimensional space and observed at an observation point. The indoor positioning map memory stores three-dimensional space data of the lighting device. According to a three dimensions (3D) principle, an assumed camera can generate, in different places and from different perspectives, different two-dimensional mappings that may also be referred to as two-dimensional simulation views, and the obtained two-dimensional mappings are matched with the two-dimensional pictures obtained by the camera. When it is learned, using a correlation matching algorithm, that one of the mappings has a particular degree of similarity with a two-dimensional picture obtained by the camera, an observation point and a perspective of the mapping are relatively close to an actual location and perspective of the positioning terminal. During the matching of the positioning pictures with the three-dimensional data, different observation points and perspectives are sequentially traversed. The degree of similarity is described by a matching degree in the following, and generally, an observation point and a perspective that are of a two-dimensional simulation view that has a higher matching degree indicates that the observation point and the perspective are closer to an actual location and perspective of the positioning terminal.

When a matching degree of the foregoing correlation matching does not reach a threshold requirement, for example, higher positioning accuracy is needed, a round of finer correlation matching between an observation sampling point and an perspective sampling point is performed around the foregoing approximately matched observation point and perspective, and so on, so that higher positioning accuracy is obtained.

In order to implement the foregoing correlation matching more easily, more camera shooting parameters are used, which can significantly improve efficiency of a matching operation. For example, the terminal measures, using a three-dimensional acceleration sensor, a three-dimensional attitude that is used when the camera shoots a picture. In this way, when the matching operation is being performed, many unnecessary pitch angles can be saved, thereby improving matching efficiency. Because cameras of terminals have different models, wide angles at which a landscape is shot are different. When matching is performed between a database of three-dimensional data of a lighting device and a photographic picture, different wide angles affect accuracy of the correlation matching. More preferably, matching to a same wide angle should be first performed, and then the correlation matching is performed. It may be that a two-dimensional simulation view uses a wide angle of the photographic picture, or may be that a camera shooting module or a picture is first preprocessed and a wide angle consistent with a two-dimensional simulation view is used. There are some distortions in cameras of some models, and such a distortion usually manifests itself at a fixed location in an image. Before the correlation matching, such a distortion may be corrected. These are all effective manners to improve positioning efficiency and accuracy.

A physical shape and location are used in the foregoing correlation matching. A color and spacing may also be used for matching. Each indoor lighting device generally has a particular natural distinction in chromatic aberration, a location, and a spacing, which makes two-dimensional simulation views at different observation points in this embodiment are not completely the same such that a result of the matching from three-dimension to two-dimension is unique. However, if a layout of indoor lighting devices has similarities or is symmetric, multiple observation points and perspectives may be positioned and matched in this embodiment. However, actually, when the user implements indoor navigation, a new location is always correlated with information about previous positioning. A result that accords with logic may be selected from multiple results such that the multiple results may be reduced to a unique result. If the indoor lighting devices have similarities or are symmetric, a change may also be performed on some lighting devices, and a small change can easily damage such similarities or symmetry on the whole.

In this embodiment, a location of a terminal in three-dimensional space may be positioned, and an orientation of a camera may further be determined. The method of a mapping from three-dimension to two-dimension in this embodiment may also be implemented using another algorithm.

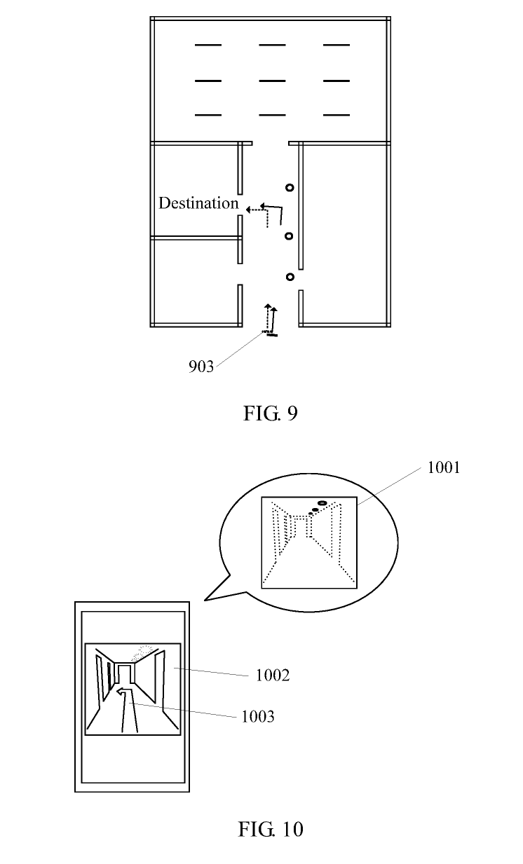

FIG. 8, FIG. 9, and FIG. 10 show embodiments for displaying a positioning result of a terminal used for indoor positioning. For simplicity, reference is made to another embodiment in this embodiment of the present disclosure, that is, a correlated part in the another embodiment may be used to support this embodiment and may be a part of this embodiment .

FIG. 8 is a horizontal mapping diagram of indoor space, which includes a positioning terminal 801 and a destination 802. An arrow 803 represents an actual direction from the positioning terminal 801 to the destination 802. The positioning terminal 801 performs positioning according to an image of an indoor lighting device 804 captured by a camera of the positioning terminal 801 and according to an indoor positioning map stored by the positioning terminal. A dashed line 903 in FIG. 9 is a location of the terminal and an orientation of the camera of the terminal that are obtained by the positioning terminal by positioning. This embodiment aims to show that there is an error between a positioning result of the terminal and reality. For ease of understanding of this embodiment, the error is made to be obvious. In actual use, accuracy of positioning by the camera depends on a camera shooting accuracy and definition of the camera. Accuracy of a positioned location may reach 2 to 3 centimeter (cm) or even higher. An angle error of a positioning direction may be within one degree. This example should not be understood as that positioning accuracy in this embodiment is shown in FIG. 9.

The positioning terminal of this embodiment shown in FIG. 10 can obtain, with low exposure, a positioning image 1001. In addition, the positioning terminal further controls the camera to perform normal exposure shooting in order to obtain an image 1002 that is clear and comfortable for eyes, where most areas of the image are exposed properly, but a top lighting device is overexposed to some extent such that the lighting device and its surroundings are in an oversaturated brightness state. The positioning terminal of this embodiment controls the camera to obtain the positioning image 1001 and the normal image 1002 respectively. The positioning terminal may shoot the two images within a relatively short time interval. A location and an orientation of the camera do not change a lot when the two images are shot. However, a tone of the positioning image 1001 is dim, and is not suitable for a human eye to observe. After a location and an orientation of the terminal are positioned using the positioning image 1001, the positioning terminal performs display enhancement using the image 1002. An arrow 1003 in the figure indicates information about navigation of a next step of a user. Such a display enhancement manner integrates a picture suitable for a human eye to observe with information output using positioning, which is easy for the user to read and use, thereby greatly improving user experience. Such a display enhancement manner is also referred to as virtual reality. The foregoing describes a shooting manner of the image 1002. The image 1002 may also be generated using another manner. For example, the image 1002 may be obtained by increasing brightness of the image 1001, although this may cause a hot pixel of a new image to increase, and two types of images may be respectively shot using two or more different cameras of the terminal.

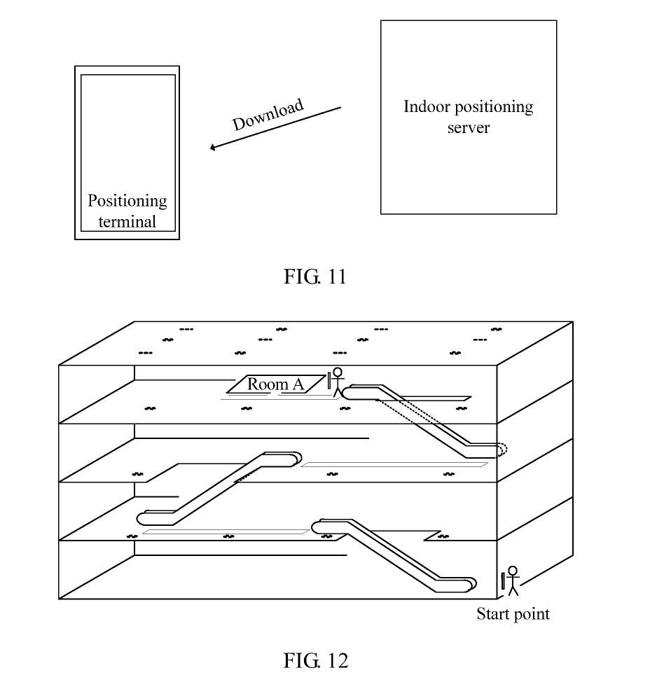

The following is a third embodiment of an indoor positioning terminal. The positioning terminal shown in FIG. 11 further includes a communication module (not shown in the figure). The positioning terminal downloads in advance a positioning map from an indoor positioning server using the communication module, where the positioning map includes an indoor electronic map that records an indoor channel and a room and three-dimensional space data that is of an indoor lighting device used for positioning reference and relative to the indoor electronic map. The lighting device herein may be a lamp, a skylight on a roof, a bright window, and the like. The indoor electronic map may be a two-dimensional or three-dimensional map. The downloading herein may be pre-downloading, or instant downloading using wireless communication, or pushing by a server.

As shown in FIG. 12, when the user enters a building that provides an indoor positioning service while holding the terminal shown in FIG. 11, and starts navigation of the positioning terminal, a destination set in the terminal is a room A on the fourth floor. The user terminal further needs to obtain a current location of the user terminal, where the current location may be obtained by positioning by the terminal itself, or may be inputted by the user, or may be obtained by positioning by the terminal using another positioning method, such as wireless network positioning. If the initial location is positioned by the positioning terminal using an image of an indoor lighting device, the terminal may at most needs to match a three-dimensional data model of lighting devices in the whole building, which may consume much computing time. However, once the positioning terminal traces its own location and enters a navigation state, according to a normal walking speed of a human and a direction trend, and using a correlation between a current positioning location and a previous location, a searching and matching range may be narrowed and positioning processing is accelerated. After determining the current location, the positioning terminal may further search a proper route according to a destination address, and indicate the proper route to the user.

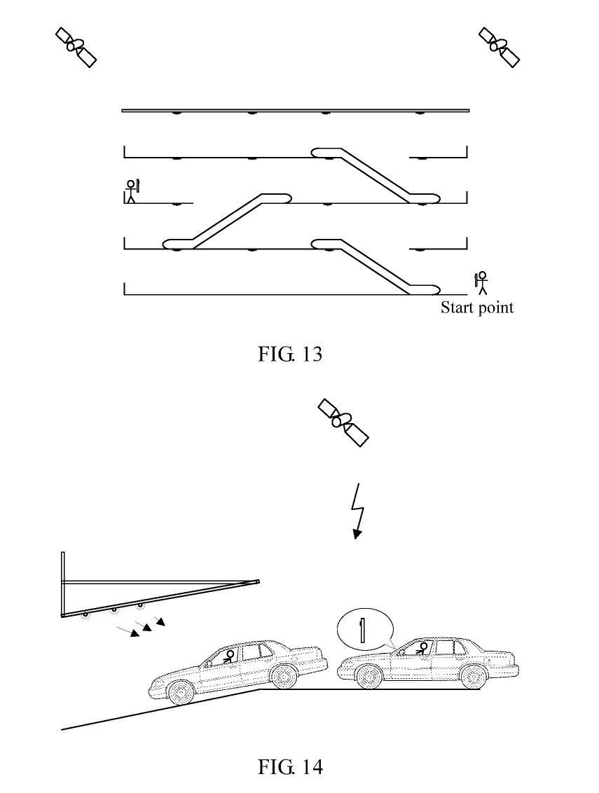

FIG. 13 is an embodiment of positioning by a positioning terminal with assistance of a positioning satellite. The positioning terminal of this embodiment may further include a satellite positioning system module, such as the GPS and China's Beidou navigation module in order to determine an initial location. When the positioning terminal approaches a window indoors, the positioning terminal has an opportunity to collect some satellite signals, such as signals of one to three satellites. These satellite signals are combined with existing general geographic information, and the satellite signals may be used to improve accuracy of a positioned location.

FIG. 14 is an embodiment of a positioning terminal that integrates indoor and outdoor positioning technologies, which further includes a camera and a satellite positioning system module. The satellite positioning system module is configured to perform satellite positioning of an outdoor road. The camera is configured to perform indoor positioning, and a camera module is on the back of a screen of the positioning terminal. The screen of the terminal faces a driver, and the camera faces a front indoor environment. The two positioning modules are scheduled in a same navigation application, which implements seamless switchover of outdoor and indoor navigation.

An indoor lighting device may be partly damaged, or some lamps may be temporarily added. Therefore a positioning computing module needs to have a fault tolerance processing capability when performing matching. The positioning computing module may store a found difference. When the positioning terminal can access a communications network, the terminal sends difference information found by the terminal to an indoor map server. After performing analysis and determining, the indoor positioning server updates indoor positioning map data, thereby facilitating another positioning user in downloading latest indoor positioning map.

In another implementation manner of the positioning terminal of the present disclosure, a wireless network communication module of the positioning terminal communicates with a corresponding wireless communications network to locate a general area of the user terminal using the wireless network. The wireless network communication module is configured to measure signal strength of the wireless network, interact with the wireless network, and locate the general area in which the user terminal is located. After obtaining a positioning image, the positioning computing module of the positioning terminal performs positioning correlation matching processing of a lighting device preferably or only in the foregoing general area. A type of the wireless communications network may be one of a wireless local area network (WLAN), BLUETOOTH, or second generation (2G), third generation (3G), fourth generation (4G), or even a future fifth generation (5G) communications system or gigabit wireless (GIFI).

In another implementation manner of the positioning terminal of the present disclosure, the positioning terminal may further include two or more cameras, and two cameras may obtain a stereo indoor image. In this way, the positioning terminal may obtain a three-dimensional data model of an indoor lighting device. Matching positioning is directly performed between the three-dimensional data model of the indoor lighting device and a three-dimensional positioning reference, which saves a mapping from three-dimensional data of the lighting device to a two-dimensional simulation view, and improves matching positioning efficiency.

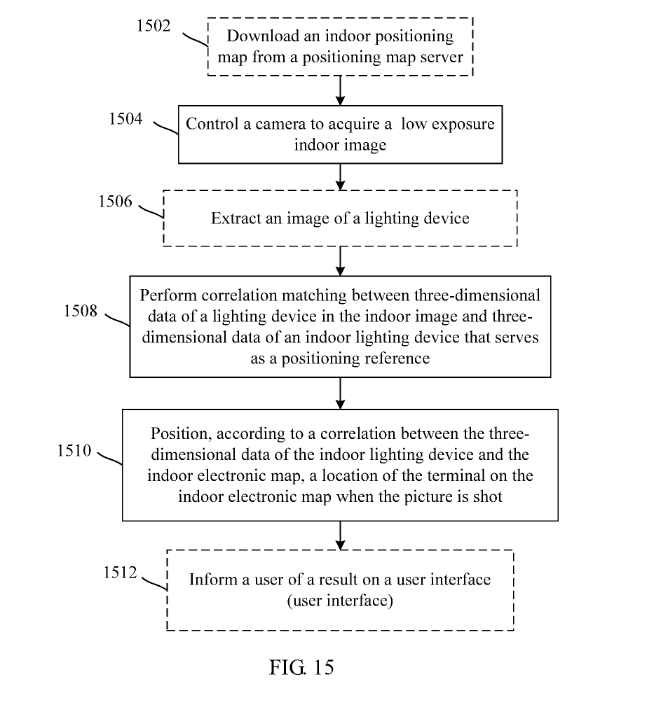

As shown in FIG. 15, FIG. 15 shows a first embodiment of a method for a positioning terminal. This embodiment includes the following steps.

Step 1504: Control a camera to acquire a low exposure indoor image.

Step 1508: Using an image of a lighting device in the indoor image and positioning reference data of a three-dimensional lighting device in an indoor electronic map, perform correlation matching between three-dimensional data of the lighting device in the indoor image and three-dimensional data of the indoor lighting device that serves as a positioning reference.

Step 1510: Position, according to a correlation between the three-dimensional data of the indoor lighting device and the indoor electronic map, a location of the terminal on the indoor electronic map when the picture is shot, and output an orientation of the camera of the terminal.

Step 1504 of controlling a camera to acquire a low exposure indoor image further includes controlling the camera to collect the image by shortening exposure time or zooming out an aperture of a lens. Because brightness of the indoor lighting device is very different from brightness of indoor background, more preferably, shooting may be performed by reducing 2-4 grades of exposure such that the lighting device is imaged clearly, but a surrounding background is dimmed.

This embodiment may further include the following optional steps. Between step 1504 and step 1508 in this embodiment, step 1506 of extracting an image of the lighting device is added. Step 1506 further includes suppressing an image of a surrounding environment, and extracting information such as an outline and a color of the lighting device.

Step 1512 of informing a user of a result on a user interface is further included.

Step 1512 further includes calculating a navigation direction of a next step according to a positioning location, an orientation of the camera, and a set destination, controlling the camera to acquire a normal indoor image, and enhancing display of the navigation information of the next step using a method of virtual reality.

Before step 1504 of this embodiment, step 1502 of downloading an indoor positioning map from a positioning map server is further included.

In step 1508, the correlation matching further includes performing correlation matching having a fault tolerance processing capability. When some lighting devices do not match three-dimensional data, but other lights have higher matching degrees, it is considered that the matching is successful, and a positioning result is outputted.

The foregoing step further includes sending, using a communication module, a found difference between the some lighting devices and the three-dimensional data information to an indoor positioning server.

Step 1504 further includes acquiring a wide angle that is used by the camera to capture the indoor picture. Then, the correlation matching in step 1508 further includes matching the three-dimensional data of the indoor lighting device to a two-dimensional simulation view with a same wide angle according to the wide angle of the indoor picture, and then performing the correlation matching.

Step 1504 further includes acquiring a three-dimensional space attitude of the camera. Then, the correlation matching in step 1508 further includes performing the correlation matching with the three-dimensional data of the indoor lighting device according to an attitude the same as the three-dimensional space attitude of the camera.

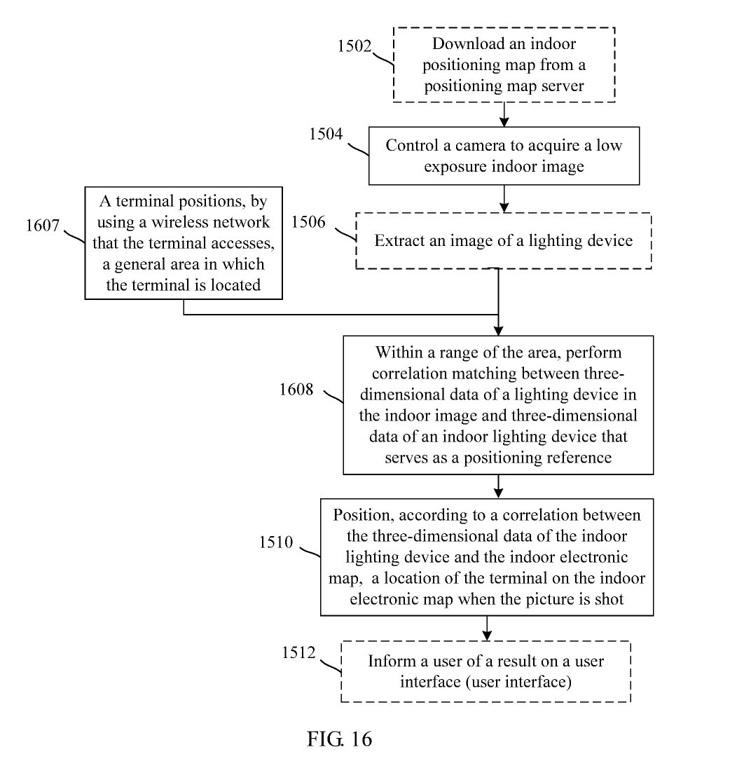

As shown in FIG. 16, FIG. 16 shows another embodiment of a method for a positioning terminal. Differences between this embodiment and the previous embodiment lie in:

Step 1607: A terminal positions, using a wireless network that the terminal accesses, a general area in which the terminal is located.

Step 1608: Within a range of the area, perform correlation matching between three-dimensional data of a lighting device in the indoor image and three-dimensional data of an indoor lighting device that serves as a positioning reference.

Another embodiment of a method for a positioning terminal is similar to the method in which a general area of a terminal is determined in advance using a wireless network. The method includes steps: collecting a satellite signal using a satellite positioning system module of the positioning terminal to determine a general area of the terminal. If accuracy of satellite positioning is high enough, the general area of the terminal may further be used as a start point of indoor navigation of a next step.

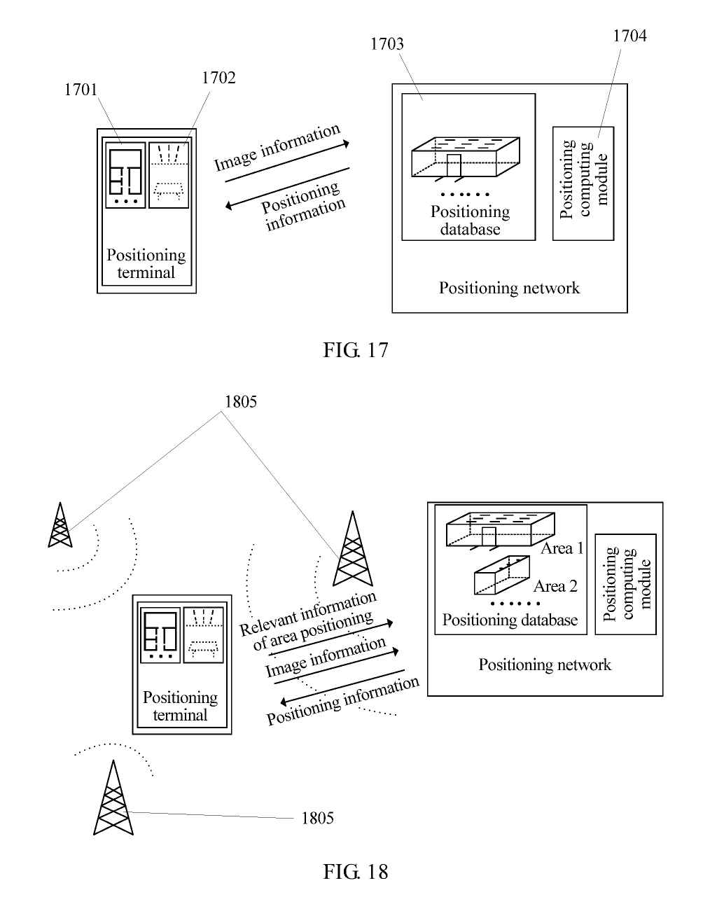

As shown in FIG. 17, FIG. 17 shows an embodiment of a positioning system that includes a positioning terminal and a positioning network. This embodiment may also be understood as including an embodiment of a positioning terminal and an embodiment of a positioning network.

The positioning terminal includes an indoor electronic map storage module 1701, a terminal camera module 1702, and a terminal communication module (not shown in FIG. 17). The indoor electronic map storage module 1701 may be a non-volatile memory or may be a RAM, and is stored by application software. The indoor electronic map storage module 1701 in FIG. 17 exemplarily indicates that the storage module 1701 stores an electronic map of the areas in FIG. 4. Actually, the storage module includes electronic maps of all areas that provide a positioning service, and other areas are not drawn, and are represented by apostrophes in the figure. The terminal communication module stored in the indoor electronic map storage module may be configured to communicate with the positioning network.

The positioning network includes a positioning database 1703, a positioning computing module 1704, and a positioning network communication module (not shown in the figure). The positioning database is configured to store three-dimensional space data of a positioning reference (an indoor lighting device). Three-dimensional data coordinates of the lighting device may also be correlated with the indoor electronic map and use a same frame of reference such that a location positioned according to three-dimensional space data of the indoor lighting device can point to the indoor electronic map. Using a same frame of reference may be that the three-dimensional space data and the indoor electronic map use a same third-party frame of reference, or may be that one party takes the other party as a frame of reference, and vice versa. The positioning database 1703 in FIG. 17 exemplarily indicates that the positioning database 1703 includes three-dimensional space data of the lighting device in area 1 of FIG. 4. The positioning database may include three-dimensional data information of positioning references of all areas that provide the positioning service, and other areas are not drawn, and are represented by apostrophes in the figure. The positioning computing module 1704 is configured to perform correlation matching between an image from the terminal and three-dimensional data of a lighting device. The communication module is configured to communicate with the positioning terminal and receive a positioning request sent by the positioning terminal and an image sent by the positioning terminal.

The positioning terminal reports an acquired low exposure image to the positioning network. Before reporting, the positioning terminal may also preprocess the image such that the image can be more easily transmitted using the communication module. For example, data of the image is compressed, or the image is abstracted as a data model, or another manner is used.

After receiving a positioning request from the terminal and receiving a positioning image sent by the positioning terminal, the positioning network performs matching from two-dimension space to three-dimension space using its own computing resource in order to position a location of the positioning terminal and an orientation of a camera of the positioning terminal. A positioning result is sent to the positioning terminal. The positioning terminal may display a current location with reference to the electronic map or calculate an action direction of a next step to a destination.

The positioning computing module of the positioning network may further perform correlation matching having fault tolerance on the image reported by the positioning terminal. There may be a case in which a lighting device in an indoor environment is damaged or is added, and in this case, difference information is found by matching positioning and is recorded, and the positioning database is updated such that another positioning user downloads a latest positioning database.

In order to more easily match the foregoing mapping from three-dimension to two-dimension, more camera shooting parameters are used, which can significantly improve efficiency of a matching operation. For example, the terminal measures, using a three-dimensional acceleration sensor, a three-dimensional attitude that is used when the camera shoots a picture. In this way, when the matching operation is being performed, many unnecessary pitch angles can be saved, thereby improving matching efficiency. Because cameras of terminals have different models, wide angles at which a landscape is shot are different. When matching is performed between a database of three-dimensional data of a lighting device and a photographic picture, different wide angles affect a matching degree of the correlation matching. More preferably, matching to a same wide angle should be first performed, and then the correlation matching is performed. It may be that a two-dimensional simulation view uses a wide angle of the photographic picture, or may be that a camera shooting module or a picture is first preprocessed and a wide angle consistent with a two-dimensional simulation view is used. There are some distortions in cameras of some models, and such a distortion usually manifests itself at a fixed location in an image. Before the correlation matching, such a distortion may be corrected. These are all effective manners to improve positioning efficiency and accuracy. Efficiency of the mapping from three-dimension to two-dimension may also be improved using another algorithm.

As shown in FIG. 18, FIG. 18 shows another embodiment of a positioning system that includes a positioning terminal and a positioning network. This embodiment may also be understood as including an embodiment of a positioning terminal and an embodiment of a positioning network.

On the basis of the previous embodiment, the positioning network of this embodiment further includes a wireless network 1805. A distance from an antenna is estimated by measuring signal strength of different antennas in order to determine a general area in which the user terminal is located. An entity that executes the determining may be in the terminal or in the wireless network 1805. If the terminal performs location determining, the terminal needs to obtain power values of reference signals at various antenna transmitting ends and obtains a power value of a signal at a location of the terminal by measuring by the terminal. If the wireless network 1805 performs the location determining, the terminal needs to measure power values of signal of the antennas and reports the power values to the wireless network.

The positioning terminal of this embodiment reports the general area positioned by the positioning terminal to the positioning network, or reports collected information about signal strength of a surrounding antenna to the wireless network, and the wireless network determines the general area in which the terminal is located, and then sends the general area to the positioning network. The wireless network first positions an area, and then a positioning computing module of the positioning network performs matching from a three-dimensional positioning reference data model to two-dimension in the area. The wireless network herein may be one of a WLAN, BLUETOOTH, or 2G, 3G, 4G, or a future 5G communications system or GIFI.

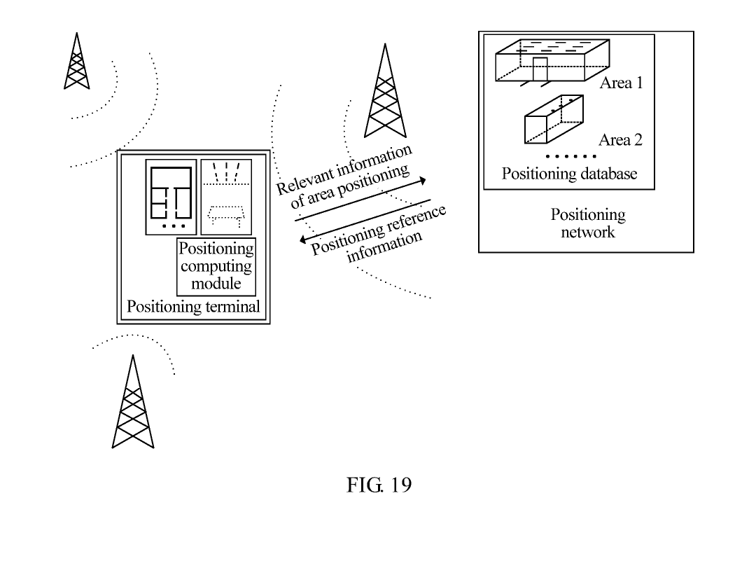

As shown in FIG. 19, FIG. 19 shows another embodiment of a positioning system that includes a positioning terminal and a positioning network. This embodiment may also be understood as including an embodiment of a positioning terminal and an embodiment of a positioning network.

The positioning network in this embodiment obtains an area in which the positioning terminal is located. To obtain the area in which the positioning terminal is located, in one situation, the positioning terminal may report information about an area that the positioning terminal positions to the positioning network. In another situation, the positioning terminal reports collected information about signal strength of a surrounding antenna to a wireless network, and the wireless network determines the area in which the terminal is located and then sends the area to the positioning network.

The positioning network sends positioning reference information data in the area in which the positioning terminal is located to the terminal, and a positioning computing module in the terminal performs correlation matching in the area. The positioning terminal acquires an indoor picture by itself and performs correlation matching using an indoor positioning reference. Times of communication between the positioning network and the positioning terminal in the foregoing embodiment are reduced, and a response speed of positioning is improved such that the positioning system can be used in a more real-time navigation application.

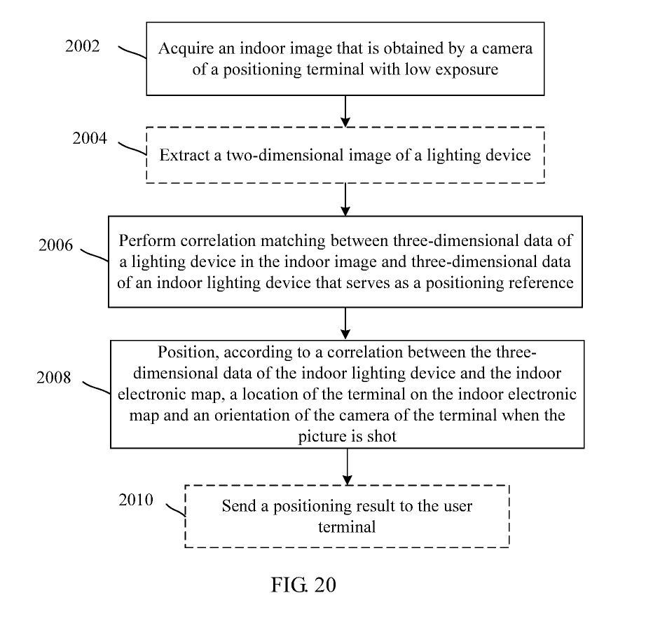

As shown in FIG. 20, FIG. 20 shows an embodiment of a method for a positioning network. The following steps performed from a perspective of the positioning network. From these steps, a corresponding execution step of a method performed by a positioning terminal may be deduced.

Step 2002: Acquire an indoor image that is obtained by a camera of a positioning terminal with low exposure.

Step 2004: Extract a two-dimensional image of a lighting device. A step in a dashed box in the figure is an optional step, and other contexts are similar.

Step 2006: Using the image of the lighting device in the indoor image and positioning reference data of a three-dimensional lighting device in an indoor electronic map, perform correlation matching between three-dimensional data of the lighting device in the indoor image and the three-dimensional data of the indoor lighting device that serves as a positioning reference.

Step 2008: Position, according to a correlation between the three-dimensional data of the indoor lighting device and the indoor electronic map, a location of the terminal on the indoor electronic map and an orientation of the camera of the terminal when the picture is shot.

Step 2010: Send a positioning result to the terminal.

Step 2004 further includes suppressing an image of a surrounding environment, and extracting information such as an outline and a color of the lighting device.

In step 2006, implementing the correlation matching further includes performing correlation matching having a fault tolerance processing capability. When some lighting devices do not match the three-dimensional data, but other lights have higher matching degrees, it is considered that the matching is successful, and a positioning result is outputted.

Step 2006 further includes the following step. Updating the three-dimensional data of the indoor lighting device that serves as the positioning reference, using a found difference between the some lighting devices and the three-dimensional data information.

Step 2002 further includes acquiring a wide angle that is used by the camera to capture the indoor picture. Then, the correlation matching in step 2006 further includes matching the three-dimensional data of the indoor lighting device to a two-dimensional simulation view with a same wide angle according to the wide angle of the indoor picture, and then performing the correlation matching.

Step 2002 further includes acquiring a three-dimensional space attitude of the camera. Then, the correlation matching in step 2006 further includes performing the correlation matching with the three-dimensional data of the indoor lighting device according to an attitude the same as the three-dimensional space attitude of the camera.

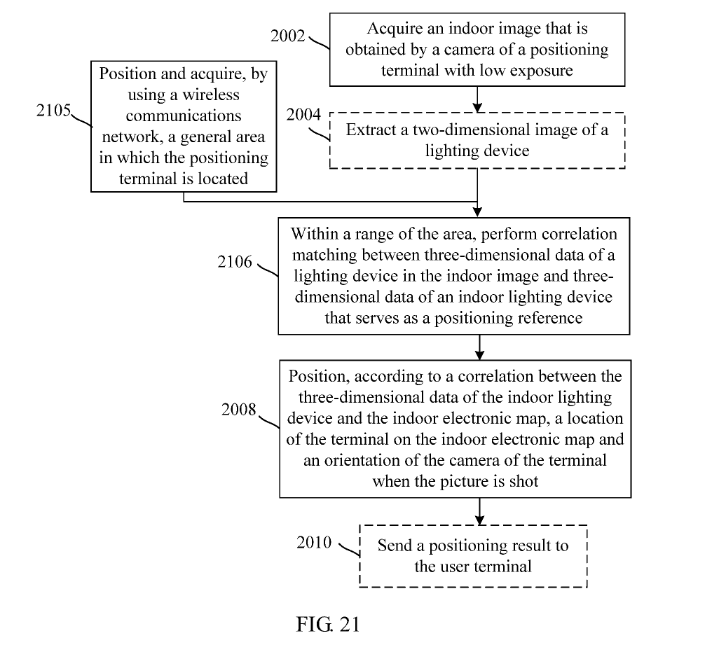

As shown in FIG. 21, FIG. 21 shows another embodiment of a method for a positioning network. The following is steps performed from a perspective of the positioning network. From these steps, it is not difficult to deduce a corresponding execution step of a method performed by a positioning terminal. Relative to the previous embodiment, steps that are added in this embodiment are:

Step 2105: Position and acquire, using a wireless communications network, a general area in which the positioning terminal is located.

Step 2106: Within a range of the area, perform correlation matching between three-dimensional data of a lighting device in the indoor image and three-dimensional data of an indoor lighting device that serves as a positioning reference.

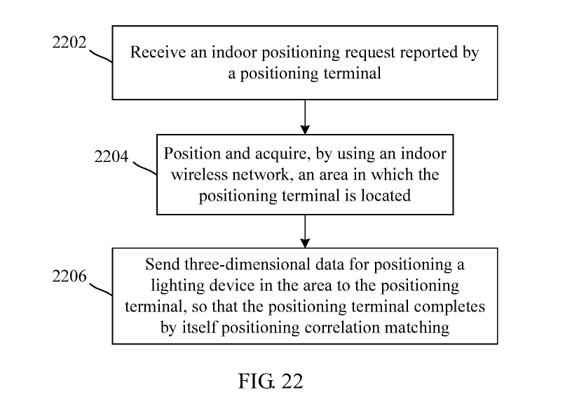

As shown in FIG. 22, FIG. 22 shows another embodiment of a method for a positioning network. The following is steps performed from a perspective of the positioning network. From these steps, it is not difficult to deduce a corresponding execution step of a method performed by a positioning terminal.

Step 2202: Receive an indoor positioning request reported by a positioning terminal.

Step 2204: Position and acquire, using an indoor wireless network, an area in which the positioning terminal is located.

Step 2206: Send three-dimensional data for positioning a lighting device in the area to the positioning terminal such that the positioning terminal completes by itself positioning correlation matching.

The positioning network sends a positioning reference information database of the area in which the terminal is located to the terminal, or the terminal downloads the reference information database from a specified address. A positioning computing module in the terminal performs matching from three-dimension to two-dimension in the area. The terminal acquires an indoor picture by itself and performs correlation matching computing using an indoor positioning reference, which reduces multiple times of reciprocating communication and improves a response speed of positioning such that the terminal can be used in a more real-time navigation application.

A person of ordinary skill in the art may be aware that, in combination with the examples described in the embodiments disclosed in this specification, units and algorithm steps may be implemented by electronic hardware, computer software, or a combination of computer software and electronic hardware.

Steps of methods or algorithms described in the embodiments disclosed in this specification may be implemented by hardware, a software module executed by a processor, or a combination thereof The software module may be configured in a RAM, a memory, a ROM, an electrically programmable ROM, an electrically erasable programmable ROM, a register, a hard disk, a removable disk, a compact disk read-only memory (CD-ROM), or a storage medium in any other forms well-known in the art.

What is claimed is:

1. An indoor positioning terminal, comprising:
a memory;
a camera; and
a processor, wherein the memory, the camera and the processor are coupled to each other,
wherein the camera is configured to capture, with low exposure, a picture of an indoor lighting device,
wherein the memory is configured to store indoor positioning map data, wherein the indoor positioning map data comprises an indoor electronic map and three-dimensional data information of the indoor lighting device that use a same frame of reference, and
wherein the processor is configured to:
perform correlation matching between the three-dimensional data information of the indoor lighting device and the captured picture of the indoor lighting device; and
position a location of the indoor positioning terminal on the indoor electronic map when the picture is acquired.

2. The terminal according to claim 1, wherein the processor is further configured to:
perform the correlation matching, wherein the correlation matching has a fault tolerance processing capability; and
estimate a matching degree using another lighting device when there is a difference in some lighting devices between the picture of the indoor lighting device and the three-dimensional data information.

3. The terminal according to claim 1, wherein the processor is further configured to output an orientation of the camera of the indoor positioning terminal.

4. The terminal according to claim 1, wherein the processor is further configured to:
acquire a wide angle that is used by the camera to capture the picture of the indoor lighting device;
map the three-dimensional data information of the indoor lighting device into a two-dimensional simulation view with a same wide angle according to the wide angle of the indoor picture; and
perform the correlation matching.

5. The terminal according to claim 1, wherein the processor is further configured to:
acquire a three-dimensional space attitude of the camera; and
perform the correlation matching with the three-dimensional data information of the indoor lighting device according to an attitude same as the three-dimensional space attitude of the camera.

6. The terminal according to claim 1, further comprising:
a wireless network communicator coupled to the processor and configured to:
measure signal strength of a wireless network;
exchange information with the wireless network;
locate an area in which a user terminal is located, and
wherein the processor is further configured to perform, in the area, the correlation matching between the picture of the indoor lighting device and the three-dimensional data information of the indoor lighting device.

7. The terminal according to claim 1, further comprising a satellite positioning system coupled to the processor and configured to collect signals of some positioning satellites, wherein the signals of some positioning satellites are used to perform correction on an indoor positioning location with reference to existing indoor location information.

8. The terminal according to claim 1, wherein the processor is further configured to control the camera to acquire two types of images:
a first type of image is used for indoor positioning; and
a second type of image is used for a virtual reality display of a positioning result.

9. A method for an indoor positioning terminal, comprising:
controlling a camera to acquire, with low exposure, an indoor image;
performing correlation matching between three-dimensional data of a lighting device in the indoor image and three-dimensional data of an indoor lighting device that serves as a positioning reference using an image of the lighting device in the indoor image;
positioning reference three-dimensional data of the lighting device in an indoor electronic map; and
positioning, according to a correlation between the three-dimensional data of the indoor lighting device and the indoor electronic map, a location of the indoor positioning terminal on the indoor electronic map when the picture is shot.

10. The method according to claim 9, wherein positioning, according to the correlation between the three-dimensional data of the indoor lighting device and the indoor electronic map, the location of the indoor positioning terminal on the indoor electronic map when the picture is shot further comprises positioning an orientation of the camera of the indoor positioning terminal according to the correlation between the three-dimensional data of the indoor lighting device and the indoor electronic map.

11. The method according to claim 9, wherein performing correlation matching between three-dimensional data of the lighting device in the indoor image and three-dimensional data of the indoor lighting device that serves as the positioning reference using the image of the lighting device in the indoor image further comprises:
performing correlation matching having fault tolerance processing; and
estimating a matching degree using another lighting device when there is a difference in some lighting devices between the image of the indoor lighting device and three-dimensional data information.

12. The method according to claim 11, further comprising sending the found difference between the some lighting devices and the three-dimensional data information to an indoor positioning server using a communicator.

13. The method according to claim 9, further comprising:
acquiring a wide angle that is used by the camera to capture the indoor image, and
wherein performing the correlation matching further comprises:
matching the three-dimensional data of the indoor lighting device to a two-dimensional simulation view with a same wide angle according to the wide angle of the indoor picture; and
performing the correlation matching.

14. The method according to claim 9, further comprising:
acquiring a three-dimensional space attitude of the camera, and
wherein performing the correlation matching further comprises performing the correlation matching with the three-dimensional data of the indoor lighting device according to an attitude same as the three-dimensional space attitude of the camera.

15. An indoor positioning system, comprising:
a camera of a terminal;
a positioning database; and
a processor coupled to the positioning database and the camera of the terminal,
wherein the camera of the terminal is configured to capture, with low exposure, a picture of an indoor lighting device,
wherein the positioning database is configured to store three-dimensional data information of the indoor lighting device that serves as a positioning reference, wherein the three-dimensional data information of the indoor lighting device and an indoor electronic map use a same frame of reference, and
wherein the processor is configured to:
perform correlation matching between the three-dimensional data information of the indoor lighting device and the captured picture of the indoor lighting device; and
position a location of a positioning terminal on the indoor electronic map when the picture is acquired.

16. The system according to claim 15, wherein the processor is further configured to:
perform the correlation matching, wherein the correlation matching has a fault tolerance processing capability; and
estimate a matching degree using another lighting device when there is a difference in some lighting devices between the picture of the indoor lighting device and the three-dimensional data information.

17. The system according to claim 16, wherein the processor is further configured to update the positioning database according to the found difference between the some lighting devices and the three-dimensional data information.

18. The system according to claim 15, wherein the processor is further configured to:
acquire a wide angle that is used by the camera of the terminal to capture the picture of the indoor lighting device;
match the three-dimensional data information of the indoor lighting device into a two-dimensional simulation view with a same wide angle according to the wide angle of the picture of the indoor lighting device; and
perform the correlation matching.

19. The system according to claim 15, wherein the processor is further configured to:
acquire a three-dimensional space attitude of the camera of the terminal; and
perform the correlation matching with the three-dimensional data information of the indoor lighting device according to an attitude same as the three-dimensional space attitude of the camera of the terminal.
